(19) United States
(12) Patent Application Publication
(10) Pub. No.: US 2018/0136753 A1
(43) Pub. Date: May 17, 2018

(54) System and Method for Improving Touchscreen Operability

(71) Applicants: Xiangyu LUO, Shanghai (CN); Haloband, LLC, Wilmington, DE (US)

(72) Inventor: Xiangyu Luo, Shanghai (CN)

(21) Appl. No.: 15/563,998

(22) PCT Filed: Apr. 3, 2015
(86) PCT No.: PCT/CN2015/075839

§ 371 Date: Oct. 3, 2017

(51) Int. Cl. G06F 3/044

(52) U.S. Cl. CPC G06F 3/044; H01B 1/08; G06F 2203/04107

(57) ABSTRACT

An apparatus for improving touchscreen operability and methods for making and using the same. The apparatus comprises a sheet for attaching to a touchscreen. The sheet includes a functional sense region for cooperating with a functional region of the touchscreen and a functional activation region for manipulation by a user. The functional activation region can be disposed on a nonfunctional space adjacent to the touch panel, such as an area adjacent to a home button of a smartphone. Thereby, a predetermined smartphone function associated with a distal functional region of the touchscreen can be initiated via manipulation of the functional activation region, rather than activation of the functional sense region of the touchscreen. Thereby, the apparatus advantageously can enable a user of the smartphone to initiate the predetermined smartphone function associated with the distal functional region of the touchscreen in a more convenient manner, enabling single-handed operation of the smartphone.

### FIELD

The disclosed embodiments relate generally to touchscreens and more particularly, but not exclusively, to apparatuses and methods for extending a functional region of touchscreens, such as touchscreens on smartphones.

### BACKGROUND

In the world of smartphones, large touchscreens are becoming increasingly popular. One example of a popular smartphone with a large touchscreen size of over 5.5 inches is the iPhone® 6 plus smartphone manufactured by Apple Computer, Inc., of Cupertino, Calif. Users like smartphones with larger touchscreens because the larger touchscreens can display more information and/or display the information with bigger sizes. However, larger touchscreens normally cannot be conveniently operated, particularly with a single hand. This particular inconvenience exists especially for certain soft-functional regions of the touchscreen that are positioned away from a home key of the smartphone.

Some currently-available smartphones arrange functional regions at corners of the touchscreen, such as the upper-left corner or the upper-right corner. However, those functional regions are not readily accessible with a single hand, specifically for the functional region located at the upper-left corner. On the other hand, generally, the touchscreen cannot cover the entire face of the smartphone. For example, the periphery of the touchscreen of the iPhone® 6 plus smartphone is framed by the smartphone chassis.

In view of the foregoing reasons, there is a need for apparatuses and methods for providing more ready access to selected touchscreen functions associated with inconveniently-located functional regions of smartphone touchscreens.

### SUMMARY

In accordance with a first aspect disclosed herein, there is set forth an apparatus for initiating a predetermined touchscreen function associated with a functional region of a touchscreen, comprising:

a functional sense region for cooperating with the functional region of the touchscreen; and

a functional activation region for activating the predetermined touchscreen function via the functional sense region.

In an exemplary embodiment of the disclosed apparatus the functional sense region is distal from the function sense region.

In another exemplary embodiment of the disclosed apparatus the functional sense region and the functional activation region are disposed on a transparent sheet.

In an exemplary embodiment of the disclosed apparatus the the functional sense region and the functional activation region are covered with a conductive material.

In another exemplary embodiment of the disclosed apparatus the functional sense region at least partially covers the functional region.

In another exemplary embodiment of the disclosed apparatus the conductive material is selected from a group consisting of a transparent conductive material and, a nontransparent conductive material and a translucent conductive material.

In another exemplary embodiment of the disclosed apparatus the conductive material is electroplated onto the transparent sheet.

In another exemplary embodiment of the disclosed apparatus the conductive material comprises at least one of indium tin oxide (“ITO”), Aluminum Zinc Oxide (“AZO”), Gallium Zinc Oxide (“GZO”) or Indium Zinc Oxide (“IZO”).

In another exemplary embodiment of the disclosed apparatus the functional sense region communicates with the functional activation region via an electrical conductor.

In another exemplary embodiment of the disclosed apparatus the conductor between the functional sense region and the functional activation region comprises at least one conductive wire.

In another exemplary embodiment of the disclosed apparatus the conductive wire is a transparent conductive wire or a translucent conductive wire.

In another exemplary embodiment of the disclosed apparatus the conductive wire is electroplated onto the transparent sheet with a conductive material.

In another exemplary embodiment of the disclosed apparatus the conductive material comprises at least one of indium tin oxide (“ITO”), Aluminum Zinc Oxide (“AZO”), Gallium Zinc Oxide (“GZO”) or Indium Zinc Oxide (“IZO”).

In another exemplary embodiment of the disclosed apparatus the touchscreen is part of a smartphone.

In another exemplary embodiment of the disclosed apparatus the functional activation region is disposed adjacent to a home button of the smartphone.

In another exemplary embodiment of the disclosed apparatus the conductive wire is arranged along a peripheral edge region of the transparent sheet.

In another exemplary embodiment of the disclosed apparatus the transparent sheet is a protective sheet for protecting the touchscreen.

In another exemplary embodiment of the disclosed apparatus the protective sheet is an armored glass or tempering glass sheet.

In another exemplary embodiment of the disclosed apparatus the functional activation region presents indicia representing the predetermined touchscreen function.

In another exemplary embodiment of the disclosed apparatus the functional activation region receives the indicia from the functional region of the touchscreen via the functional sense region.

In another exemplary embodiment of the disclosed apparatus the functional sense region senses the indicia presented by the functional region of the touchscreen.

In accordance with another aspect disclosed herein, there is set forth a method for manufacturing an apparatus of initiating a predetermined touchscreen function associated with a functional region of a touchscreen, comprising:

enabling a functional sense region to cooperate with the functional region of the touchscreen; and

enabling the predetermined touchscreen function to be activated with a functional activation region, distal from the functional sense region, via the functional sense region.

Exemplary embodiments of the disclosed methods further comprise disposing the functional sense region and the functional activation region on a transparent sheet.

Exemplary embodiments of the disclosed methods further comprise laying a conductive material on the functional sense region and/or the functional activation region.

In another exemplary embodiment of the disclosed methods, enabling a functional sense region further comprises enabling the functional sense region to cover at least partially the functional region of the touchscreen.

In another exemplary embodiment of the disclosed methods, laying the conductive material comprises laying a material selected from a group consisting of a transparent conductive material, a nontransparent conductive material and a translucent conductive material.

In another exemplary embodiment of the disclosed methods, laying the conductive material comprises electroplating the conductive material onto the transparent sheet.

In another exemplary embodiment of the disclosed methods, electroplating the conductive material comprises electroplating at least one of indium tin oxide (“ITO”), Aluminum Zinc Oxide (“AZO”), Gallium Zinc Oxide (“GZO”) or Indium Zinc Oxide (“IZO”) to the transparent sheet.

Exemplary embodiments of the disclosed methods further comprise laying an electrical conductor between the functional sense region and the functional activation region.

In another exemplary embodiment of the disclosed methods, laying the conductor comprises laying at least one conductive wire between the functional sense region and the functional activation region.

In another exemplary embodiment of the disclosed methods, laying at least one conductive wire comprises electroplating the conductive wire onto the transparent sheet.

In another exemplary embodiment of the disclosed methods, electroplating the conductive wire comprises electroplating at least one of indium tin oxide (“ITO”), Aluminum Zinc Oxide (“AZO”), Gallium Zinc Oxide (“GZO”) or Indium Zinc Oxide (“IZO”) to the transparent sheet.

In another exemplary embodiment of the disclosed methods, laying at least one conductive wire comprises laying at least one transparent or translucent conductive wire.

In another exemplary embodiment of the disclosed methods, the touchscreen is part of a smartphone.

Exemplary embodiments of the disclosed methods further comprise disposing the functional activation region adjacent to a home button of the smartphone.

In another exemplary embodiment of the disclosed methods, laying at least one conductive wire comprises laying the conductive wire along a peripheral edge region of the transparent sheet.

In another exemplary embodiment of the disclosed methods, transparent sheet comprises armored glass or tempering glass sheet.

Exemplary embodiments of the disclosed methods further comprise presenting indicia representing the predetermined touchscreen function in the functional activation region.

In another exemplary embodiment of the disclosed methods, presenting indicia comprises receiving the indicia from the functional region of the touchscreen via the functional sense region.

In another exemplary embodiment of the disclosed methods, receiving the indicia further comprises sensing, by the functional sense region, the indicia presented by the functional region.

In accordance with another aspect disclosed herein, there is set forth an apparatus for triggering a plurality of predetermined touchscreen functions associated with functional regions of a touchscreen is configured to improve an accessibility of the touchscreen in accordance with any one of claims 22-40.

In accordance with another aspect disclosed herein, there is set forth a system for triggering a predetermined touchscreen function associated with a function area of a touchscreen is configured to improve an accessibility of the touchscreen in accordance with any one of claims 22-40.

### BRIEF DESCRIPTION OF THE DRAWINGS

FIG. 1 is an exemplary schematic diagram, illustrating an embodiment of an apparatus for improving an operability of a touchscreen.

FIG. 2 is an exemplary schematic diagram, illustrating an embodiment of a typical smartphone suitable for use with the apparatus of FIG. 1.

FIG. 3 is an exemplary schematic diagram, illustrating an alternative embodiment of the apparatus of FIG. 1, wherein the apparatus is disposed on the smartphone of FIG. 2.

FIG. 4A is an exemplary schematic diagram, illustrating another alternative embodiment of the apparatus of FIG. 1, wherein the apparatus enables two functional regions of the touchscreen to be extended to respective nonfunctional regions.

FIG. 4B is an exemplary schematic diagram, illustrating another alternative embodiment of the apparatus of FIG. 4A, wherein the apparatus enables three functional regions of the touchscreen to be extended to respective nonfunctional regions.

FIG. 5 is an exemplary schematic diagram, illustrating an alternative embodiment of the apparatus of FIG. 4A, wherein the apparatus includes conductors disposed at peripheral edge regions of the apparatus.

FIG. 6 is an exemplary schematic diagram, illustrating another alternative embodiment of the apparatus of FIG. 1, wherein the apparatus for improving an operability of a touchscreen is a protective shell for covering the touchscreen.

FIG. 7 is an exemplary schematic diagram, illustrating an alternative embodiment of the apparatus of FIG. 6, wherein the apparatus is disposed on the smartphone of FIG. 2.

FIG. 8 is an exemplary flowchart, illustrating an embodiment of a method for manufacturing an apparatus of improving an operability of a touchscreen.

FIG. 9 is an exemplary flowchart, illustrating an alternative embodiment of the method of FIG. 8, wherein a functional sense region and a functional activation region of a sheet are connected via a conductive wire.

FIG. 10 is an alternative exemplary flowchart, illustrating an alternative embodiment of the method of FIG. 8, wherein the apparatus is attached to a touchscreen.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

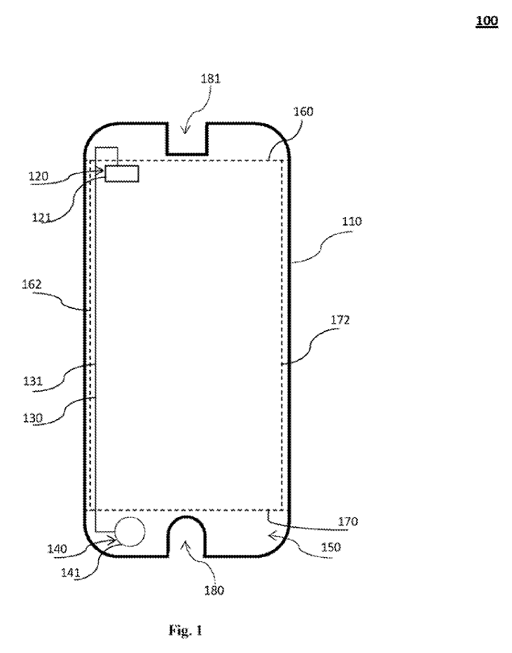

Since some touchscreen functions are associated with inconveniently-located functional regions of touchscreens, such as smartphones touchscreens, an apparatus and method for providing an alternative manner for activating those touchscreen functions can prove desirable and provide a basis for improving operability of the touchscreens. This result can be achieved, according to one embodiment of an apparatus 100 as shown in FIG. 1.

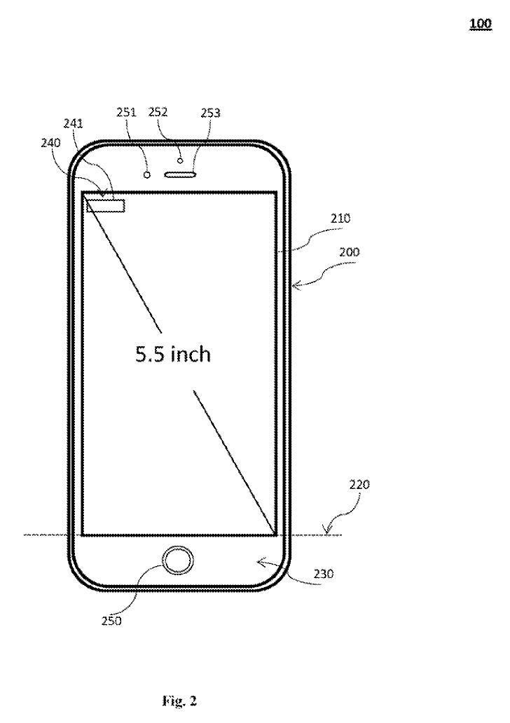

FIG. 1 illustrates an exemplary embodiment of an apparatus 100 for improving an operability of a touchscreen, such as a touchscreen 210 of a smartphone 200 (collectively shown in FIG. 2). The operability of a touchscreen 210 can be improved, for example, by extending a functional region 240 of the touchscreen 210 (collectively shown in FIG. 2). In FIG. 1, the apparatus 100 is shown as including a sheet 110 with a system for associating a functional sense region 120 to a functional activation region 140 via a conductor 130. The sheet 110 can be provided as a touchscreen protector that can be formed from any suitable transparent and/or translucent material, such as polyurethane, plastic and/or glass. The sheet 110 can be designed to fit a particular type of touchscreens, such as the touchscreen 210 of FIG. 2. Advantageously, the sheet 110 can be designed to protect the touchscreen 210 from scratches and other damage with little or no interference to an operational sensitivity of the touchscreen 210.

Although shown and described as including a sheet 110 for covering the touchscreen 210 in its entirety for purposes of illustration only, the sheet 110 of the apparatus 100 can be provide in any suitable shape, such as an “O” shape and/or a “C” shape, wherein the central region of the touchscreen 210 is not covered by the sheet 110, but the sheet 110 has at least one thin region that is disposed along the periphery of the touchscreen 210.

The sheet 110 can be designed to have a predetermined shape, size, and/or other dimensional feature that are designed to correspond with a predetermined shape, size, and/or other dimensional feature of the particular touchscreen 210. The sheet 110 can at least partially include an operable area of the touchscreen 210 and/or an inoperable area of the touchscreen 210, such as a periphery of the touchscreen 210. The predetermined size of the sheet 110 can be designed greater than, less than, and/or equal to the predetermined size of the particular touchscreen 210. For example, an area between the dash-line 160 and dash-line 170 can be designed to correspond to the functional area of the touchscreen 210. A nonfunctional area 150 of the sheet 110 is shown to be outside the area between the dash-line 160 and dash-line 170 and can correspond with an inoperable area of a smartphone.

In one embodiment, the sheet 110 can form openings 180, 181 for devices of the touchscreen 210, such as a camera 251, a proximity sensor 252, a microphone 253, and/or home button 250 (collectively shown in FIG. 2) equipped for the smartphone. Since the region adjacent to the opening 180 can correspond to an inoperable area, the functional activation region 140 can be ideal for disposing at a portion of the sheet 110 that is adjacent to the opening 180.

FIG. 1 shows the functional sense region 120, which can be defined by a first geometry, such as a first rectangle 121. The first rectangle 121, which can be transparent, defines a predetermined area of the functional sense region 120 that can be covered with conductive material for sensing and transmitting a touch signal. The functional sense region 120 can be transparent such that the conductive material is a transparent or translucent conductive material, e.g. Indium Tin Oxide (“ITO”), Aluminum Zinc Oxide (“AZO”), Gallium Zinc Oxide (“GZO”) or Indium Zinc Oxide (“IZO”). The conductive material can be electroplated onto the sheet 110 or be applied with any other suitable methods. Although shown and described as being a rectangle for illustrative purposes only, the functional sense region 120 can be a square, a round-shape, an elliptical or any other geometry with suitable size and dimensions for covering a corresponding functional region.

FIG. 1 also shows the functional activation region 140 being defined by a second geometry, such as a circle 141, located in the nonfunctional area 150. The circle 141, which can be transparent, defines a predetermined area of the functional activation region 140 that can be covered with a conductive material for sensing a user touch. The functional activation region 140 can be in any colors for decorative or indicative purposes, but preferably is transparent and/or translucent. The functional activation region 140 can be formed from a conductive material that transparent or translucent, including but not limited to ITO, AZO, GZO and IZO. The conductive material can be electroplated onto the sheet 110 or be applied to the sheet 110 with any other suitable method. Although shown and described as being a circle for illustrative purposes only, the functional activation region 140 can be a square, a rectangle, an elliptical or any other geometry with suitable size and dimensions for receiving and transmitting the user touch.

In FIG. 1, the functional sense region 120 and the functional activation region 140 can be connected with a conductor 131, which can be a conductive wire. The conductor 130 can be used to transmit an electrical current representing a touch signal generated by the functional activation region 140 in response to the user touch. The conductor 130 can be formed from a transparent or translucent material, including but not limited, to ITO, AZO, GZO or IZO. The conductive material can be electroplated onto the sheet 110 or be applied with any other suitable methods. Although shown and described as being a transparent or translucent for purposes of illustration only, the conductor 130 between the functional sense region 120 and the functional activation region 140 can be either transparent or non-transparent in any form with a capacity of transmitting a current between the functional sense region 120 and the functional activation region 140.

In order to ensure that the functional sense region 120 and the functional activation region 140 are disposed in intended locations, the apparatus 100 preferably is attached to the smartphone 200 in a proper manner. The apparatus 100 can be attached using the shape, size and/or dimensions of the sheet 100, which are designed to match the touchscreen device 200. The apparatus 100 can also be provided with certain fiducials to ensure such alignment. In FIG. 1, the sheet 110 is provided with four dash-lines, 160, 162, 170, 172 for aligning the functional area of the touchscreen 210. Other fiducial approaches can also be used for the apparatus 100, e.g. using the openings 180, 181 or making marks (not shown) for the four corners of the touchscreen 210.

Turning now to FIG. 2, which illustrates a surface of a typical smartphone 200, such as an iPhone® 6 plus, to which the apparatus 100 of FIG. 1 can be attached. The smartphone 200 can have a touchscreen 210, with a predetermined size, geometry and/or dimensions. As shown in FIG. 2, the touchscreen 210 has a diagonal dimension of 5.5 inches. At selected portion of the touchscreen 210, a third geometry, such as a rectangle 241, that defines a functional region 240 for displaying a function, such as a back button, of a selected application and/or gadget of a popular mobile operating systems, including Settings of iOS 8.x. The functional region 240, as shown in FIG. 2, is positioned at a location that is distal from a home button 250 of the smartphone 200. The distal location of the functional region 240 can make activation of the functional region 240 difficult for the user.

Although shown and described as being an iPhone® 6 plus for purposes of illustration only, the present disclosed embodiments can be used to improve any type of smartphone with a touchscreen interface.

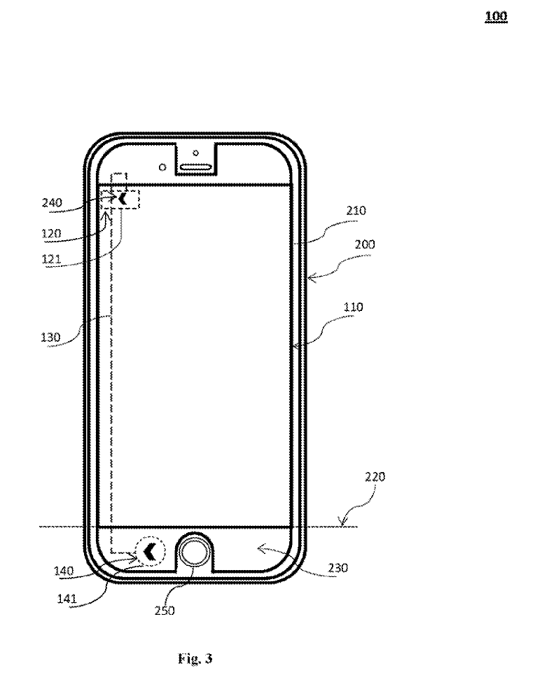

FIG. 3 shows the smartphone of FIG. 2 with the apparatus of FIG. 1 attached on the touchscreen 210 of a smartphone 200. As shown in FIG. 2, the smartphone 200 is an iPhone® 6 plus with a touchscreen 210. In the upper-left corner of the touchscreen 210, an operating system of the smartphone 200 associates a functional region 240 with a predetermined function. The predetermined function can be any one commonly used function displayed at the particular region that the apparatus 100 is designed to extend, such as a back button as shown in FIG. 3, which function can be performed by the smartphone 200. When the apparatus 100 is correctly attached, the touchscreen 210 can be at least partially covered with the sheet 110 because of its special design for the touchscreen 210. Preferably, the sheet 110 is disposed directly on top of the functional region 240 of the touchscreen 210 and covers the functional region 240 in whole and/or in part.

In FIG. 3, the functional region 220, can be extended, via the functional sense region 140 and the conductor 130, to the functional activation region 140 defined by the second geometry, such as the second circle 141. The first rectangle 121, the second circle 141 and the conductor 130 are shown in dash-lines because regions 120, 140 and the conductor 130 can be provided as transparent or translucent for purposes of displaying information under the regions 120, 140 and/or the conductor 130. The sheet 110 likewise can be associated with a nonfunctional region 230 of the smartphone 200. As shown in FIG. 3, the sheet 110 is shown as at least partially covering the nonfunctional space 230 adjacent to the home button 250 of the smartphone 200. Advantageously, by being disposed adjacent to the home button 250 of the smartphone 200, the sheet 110 can provide the second geometry, such as the circle 141 in the nonfunctional space 230, which is a location that can be more convenient for a user to access and/or manipulate.

When the user touches or otherwise manipulates the functional activation region 140, a touch signal generated by the functional activation region 140 in response to the user touch can be transmitted as an electrical current to the functional sense region 120 via the conductor 130. The signal then can pass the functional sense region 120, which is covered with a conductive material, and reach the function region 240, which signal can activate the predetermined function associated with the functional region 240. The functional activation region 140, the conductor 130 and the functional sense region 120 can ensure strength of the signal being generated and transmitted to the functional region 240.

Although shown and described as being a rectangle-shaped for the first functional region 240 located at the upper-left corner of the touchscreen of the iPhone® 6 plus for illustrative purposes only, a functional region 240 of any size, dimension or geometry located anywhere on the touchscreen of any smartphone can be extended to a convenient location.

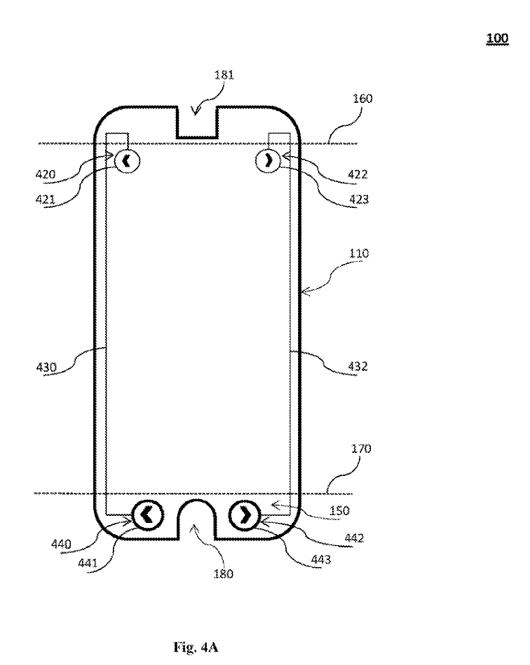

FIG. 4A illustrates an alternative embodiment of the apparatus 100 of FIG. 1. Turning to FIG. 4A, the apparatus 100 is shown as including two functional sense regions 420, 422 being extended to the nonfunctional area 150. In FIG. 4A, in addition to the first functional sense region 420 being extended via the first conductor 430 to the first functional activation region 440, a second functional sense region 422 can be extended to a second activation region 442 via a second conductor 432.

The first functional sense region 420, the first conductor 430 and the first functional activation region 440 can be provided in the same manner as shown and described with reference to the functional sense region 120, the conductor 130 and the functional activation region 140 of FIG. 1. In a similar manner, a second conductor 432 and the second activation region 442 are provided in FIG. 4A for extending the second functional sense region 422 to the nonfunctional area 150. The second conductor 432 and the second functional activation region 442 can be provided in the same manner as the conductor 130 and the functional activation region 140 shown and described with reference to FIG. 1.

Although shown and described as being two functional sense regions 420, 422 for purposes of illustration only, the present disclosed embodiments can be used for improving operability by extending three or more functional regions to the nonfunctional area 150. As an exemplary example, FIG. 4B shows a third functional sense region 424 can be extended, via a third conductor 434, to a third functional activation region 444 which is adjacent to the opening 180 in the nonfunctional area 150. The third functional sense region 424, the third conductor 434 and the third functional activation region 444 can be provided in the same manner as functional sense region 120, functional activation region 140 and the conductor 120 shown and described with reference to FIG. 1.

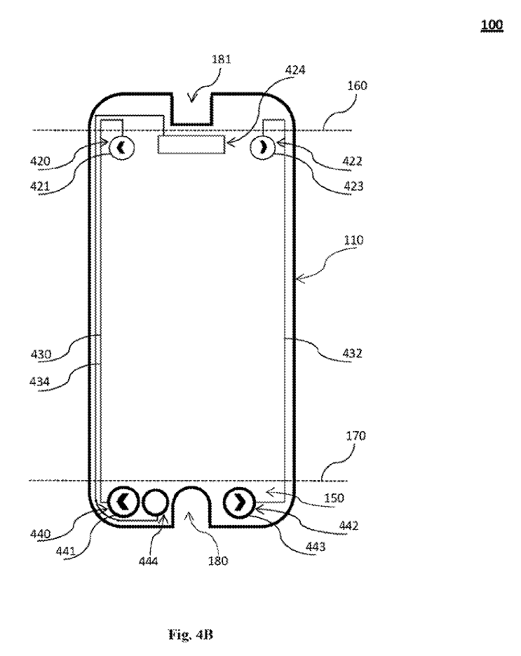

FIG. 5 illustrates another alternative embodiment of the apparatus 100 of FIG. 4A. Similar to the first and second conductors 430, 432 shown and described with reference to FIG. 4A, there can be provided with two conductors 460, 462 for extending two functional sense regions 420, 422. Unlike FIG. 4A, the two conductors 460, 462 can be disposed along two peripheral edge regions 451, 452 of the sheet 110, in FIG. 5. When running along the two peripheral edges regions 451, 452, portions of the two conductors 460, 462 coinciding with the peripheral edges regions 451, 452 can be either transparent or non-transparent. When non-transparent, the conductive wires 460, 462 can be concealed by each of the two peripheral edges regions 451, 452, where any of the conductive wires 451, 452 coincide with any of the peripheral edges 460, 462. When transparent, the conductive wires 451, 452 can be formed in the manner shown and described with reference to FIG. 4A.

Although shown and described as being either transparent or non-transparent for purposes of illustration only, the conductors 451, 452 of the present disclosed embodiments can be in any form, including but limited to being semitransparent or being in one or more color such as for decorative or indicative purposes.

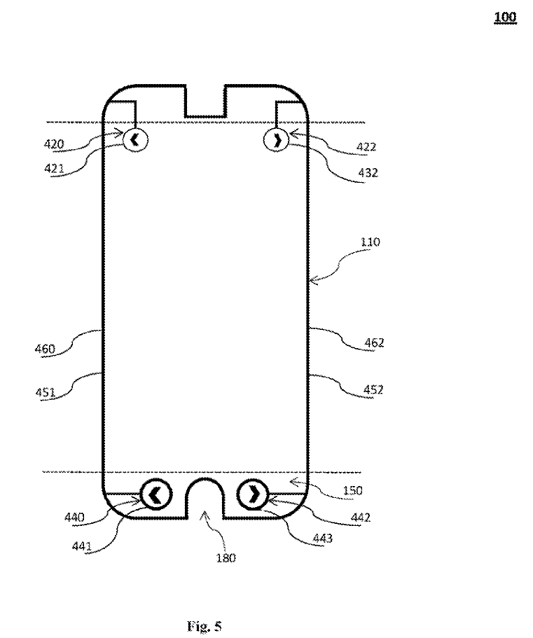

FIG. 6 illustrates another embodiment of the apparatus 600 for improving an operability of a touchscreen 200 of FIG. 4A. In FIG. 6, the apparatus 600 can comprise a protective shell 610, which can be tailored to surround a touchscreen device 200. The protective shell 610 can be formed of a plastic, rubber or a leather material. The protective shell 610 can have an opening 620 with a predetermined shape, size, and/or other dimensional feature that corresponds with a predetermined shape, size, and/or other dimensional feature of the touchscreen 210. The opening 620 can be installed with a sheet, which can at least partially include an operable area for covering a touchscreen 210, in a similar shown and described with reference to FIG. 1. The predetermined size of the sheet can be greater than, less than, and/or equal to the predetermined size of the touchscreen 210.

The protective shell 610 can also comprise other openings for exposing built-in devices of a touchscreen device 200. The touchscreen device 200 can be a smartphone, such as an iPhone® 6 plus, which can include cameras, microphones, proximity sensors and/or a home button 250. There can be spaces adjacent to the opening for the home button 250, which adjacent spaces can be used for disposing the functional activation regions 440, 442.

FIG. 6 shows two functional sense regions 420, 422, which can be defined by the first and second geometries, such as a fourth rectangle 621 and a fifth rectangle 623. The fourth and fifth rectangles 621, 623 can be transparent, defining predetermined areas of the functional sense regions 420, 422 that can be covered with conductive material for sensing and transmitting touch signals. The conductive material can be provided and/or applied with the same manner shown and described with reference to FIG. 1.

Although shown and described as including a protective shell 610 for purposes of illustration only, the apparatus 600 can include any form of shell and/or cover that can surround the smartphone 200.

FIG. 6 also shows the functional activation regions 440, 442 being defined by geometries, such as sixth and seventh circles 441, 443, located in adjacent to an opening 680 of the nonfunctional portion of the protective shell 610. The functional activate regions 440, 442 can be covered with a metallic material or an electrical conductive material as shown and described with reference to the functional activation region 140 of FIG. 1. Similar to the functional activation region 140 of the apparatus 100 of FIG. 1, the functional activation regions 440, 442 of apparatus 600 can be transparent, translucent, and/or be in any colors for decorative or indicative purposes. The functional activation regions 440, 442 can be formed from a conductive material shown and described with reference to the functional activation region 140 of FIG. 1.

In FIG. 6, the functional sense regions 420, 422 and the functional activation regions 440, 442 can be connected with conductors 430, 432 respectively, which can be conductive wires. The conductors 430, 432 can be provided in the same manner shown and described with reference to FIG. 4A. In addition, the conductors 430, 432 can be in disposed in the protective shell 610 or cross the sheet. When the conductors 430, 432 are disposed in the protective shell 610, the conductors 430, 432 are preferably disposed in a manner that they are concealed by the protective shell 610, or the conductors 430, 432 are provided in the same color as the protective shell 610.

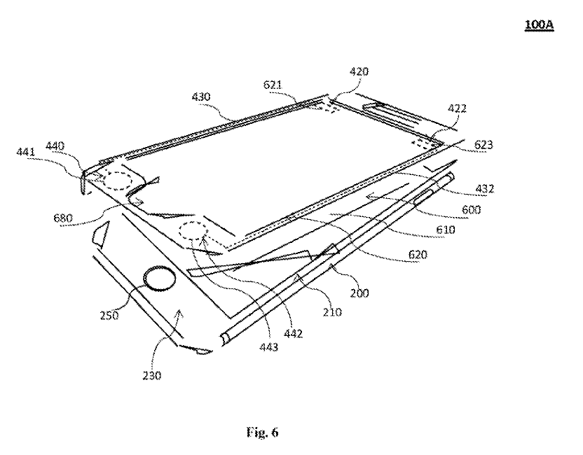

FIG. 7 shows the smartphone of FIG. 2 with the apparatus 110A of FIG. 6 attached to the smartphone 200. As shown in FIG. 7, the apparatus 600 can be disposed on the smartphone 200 such that the functional sense regions 420, 422 cover at least parts of respective functional regions and the functional activation regions 440, 442 are adjacent to the home button 250 in the same manner shown and described with reference to FIG. 3,

Although shown and described as being designed and attached to the smartphone 200, the apparatus 600 can be designed and attached to any type of touchscreen devices.

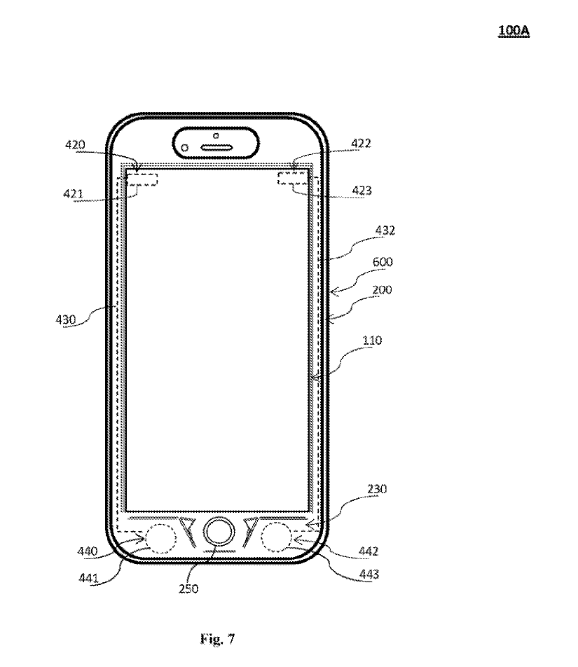

FIG. 8 illustrates an embodiment of a method 200 for manufacturing the apparatus 100 of FIG. 1 for improving an operability of a touchscreen 210. In FIG. 8, a functional sense region 120 can cooperate with a functional region 240 of a smartphone 200 with the apparatus 100, at 420. The apparatus 100 can comprise a sheet 110 that can be manufactured in the similar manner as shown and described with reference to FIG. 1. The functional sense region 120 can be provided in the same manner shown and described with reference to FIG. 1. The functional sense region 120 can be designed to associate with the functional region 240 of the touchscreen 210. The size, shape, location and/or dimensions of the functional sense region 120 can be manufactured in the same manner shown and described with reference to FIG. 1.

At 420, the apparatus 100 can be designed for a particular touchscreen 210 such that the functional sense region 120 (shown in FIG. 1) can at least partially cover the predetermined functional region 240 (shown in FIG. 2) of the touchscreen 210 for the sheet 110 to attach on the smartphone 200. To achieve this purpose, the apparatus 100 can be provided with the manner for aligning as shown and described with reference to FIG. 3. The functional region 240 is normally defined by a standard of an operating system running the touchscreen 240.

At 430, the apparatus 100 can be provided with a functional activation region 140, which communicates with the functional sense region 120 in the same manner shown and described with reference to FIG. 1. Preferably, the functional activation region 140 is disposed on the sheet 110 distally from the functional sense region 120, as shown and described with reference to FIG. 1. Because the apparatus 100 can have a functional activation region 140 that communicates with the function sense region 120 that is configured to associate with the predetermined functional region 240 of the touchscreen 210, the touchscreen function represented by the functional region 240 can be configured to be activated distally by the functional activation region 140.

Although shown and described as being configured to extend one functional region 240 for illustrative purposes only, two or more functional regions can be configured to extend for purposes of improving operability of the touchscreen 210 in the manner shown and described with reference to FIGS. 4A-7.

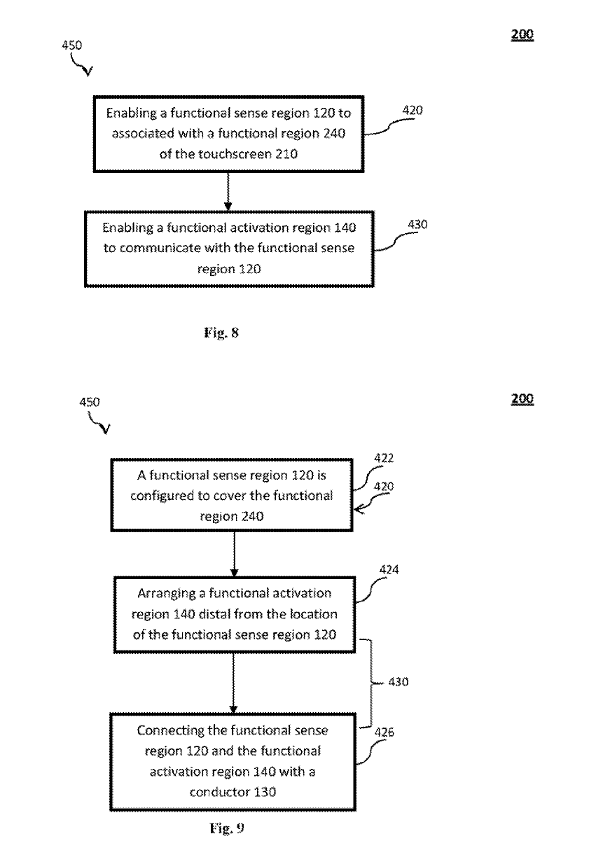

FIG. 9 illustrates an alternative embodiment of the method 200 of FIG. 8 wherein the additional detail is provided for enabling the functional activation region 140 to communicate with the functional sense region 120, at 430. In FIG. 9, at 422, the functional sense region 120 can be configured to cover at least part of the functional region 240 which associates with a touchscreen function. As shown and described with reference to FIG. 1, the functional sense region 120 can be at least partially covered with conductive material. The conductive material can be transparent in order to show indicia of the functional region 240 being displayed by the touchscreen 210. A geometry and dimension of the functional sense region 120 can depend on the geometry and dimension of the corresponding functional region 240, which geometry and dimension are normally stipulated in a standard of an operating system running the touchscreen 200.

Although shown and described as covering with conductive material for illustrative purposes, the functional sense region 120 can be covered with other material suitable for transmitting touch signal from the apparatus 100 to the functional region 240.

At 424, the functional activation region 140 can be arranged at a location that corresponds to a convenient location of the touchscreen 210. As shown and described with reference to FIG. 1, the functional activation region 140 can be arranged at the nonfunctional area 150 and adjacent to the opening 180 for the home button 250 when the apparatus 100 is applied to the touchscreen 210. Because the functional activation region 140 can be arranged adjacent to the home button 250 with the apparatus 100, operability of the touchscreen 200 can be improved.

Although shown and described as being one functional activation region 140 for one functional region 240, alternative embodiments can configure two or more functional activation regions at different locations for one functional region.

In order for the functional activation region 140 to communicate with the functional sense region 120, a connection can be provided between the two regions 140, 120, at 426. The connection can be provided with a conductor 130 between the functional sense region 120 and the functional activation region 140. As shown and described with reference to FIG. 1, the conductor 130 can be formed by any type of conductive material that can transmit electric current between the functional sense region 120 and the functional activation region 140. The conductor 130 can be transparent, non-transparent and/or in any colors. In addition, the conductor 130 between the functional sense region 120 and the functional activation region 140 can consist of a single conductive wire, a plurality of conductive wires for transmitting signals in addition to a touch.

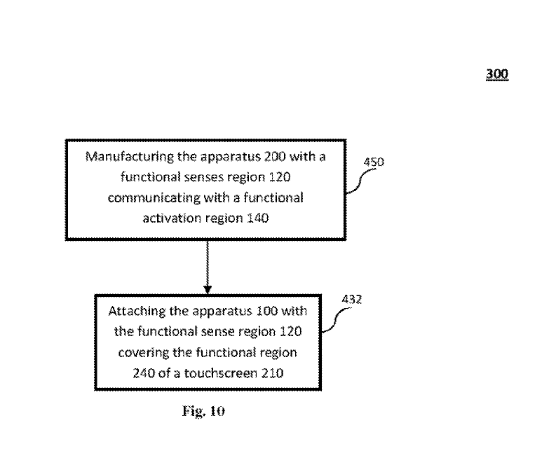

Referring now to FIG. 10, the apparatus 100 for extending the function sense region 120 can be used by attaching the apparatus 100 to the touchscreen 210, for example a smartphone. To enable a functional region 240 to be activated distally, the method 200 can include attaching the apparatus 100 onto the touchscreen 210 of the smartphone 200, at 432. The apparatus 100 can be attached such that the functional sense region 120 of the sheet 110 at least partially covers the functional region of the touchscreen 210 as described with reference to FIGS. 6 and 7. When attached, the functional activation region 140 of the sheet 110 can be located adjacent to the home button 250 in the nonfunctional space 230 of the smartphone 200. The operability of the smartphone 200 can be improved via the apparatus 100.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

1. An apparatus for initiating a predetermined touchscreen function associated with a functional region of a touchscreen, comprising:
a functional sense region for cooperating with the functional region of the touchscreen; and
a functional activation region for activating the predetermined touchscreen function via the functional sense region.

2. The apparatus of claim 1, wherein said functional sense region is distal from said function sense region.

3. The apparatus of claim 1, wherein said functional sense region is disposed on a transparent sheet, and wherein said functional activation region is disposed on the transparent sheet or on a protective shell.

4. The apparatus of claim 1, wherein said functional sense region and said functional activation region are covered with a conductive material.

5. The apparatus of claim 1, wherein said functional sense region at least partially covers the functional region.

6. The apparatus of claim 4, wherein the conductive material is selected from a group consisting of a transparent conductive material and, a nontransparent conductive material and a translucent conductive material.

7. The apparatus of claim 4, wherein the conductive material is electroplated onto the transparent sheet or the protective shell.

8. The apparatus of claim 7, wherein the conductive material comprises at least one of indium tin oxide (“ITO”), Aluminum Zinc Oxide (“AZO”), Gallium Zinc Oxide (“GZO”) or Indium Zinc Oxide (“IZO”).

9. The apparatus of claim 1, wherein the functional sense region communicates with the functional activation region via an electrical conductor.

10. The apparatus of claim 9, wherein the conductor between the functional sense region and the functional activation region comprises at least one conductive wire.

11. The apparatus of claim 10 wherein the conductive wire is a transparent conductive wire or a translucent conductive wire.

12. The apparatus of claim 10, wherein the conductive wire is electroplated onto the transparent sheet or the protective shell with a conductive material.

13. The apparatus of claim 10, wherein the conductive material comprises at least one of Indium Tin Oxide (“ITO”), Aluminum Zinc Oxide (“AZO”), Gallium Zinc Oxide (“GZO”) or Indium Zinc Oxide (“IZO”).

14. The apparatus of claim 1, wherein said touchscreen is part of a smartphone.

15. The apparatus of claim 13, wherein the functional activation region is disposed adjacent to a home button of the smartphone.

16. The apparatus of claim 10, wherein the conductive wire is arranged along a peripheral edge region of the transparent sheet.

17. The apparatus of claim 3, wherein the transparent sheet is a protective sheet for protecting the touchscreen.

18. The apparatus of claim 17, wherein the protective sheet is an armored glass or tempering glass sheet.

19. The apparatus of claim 1, wherein said functional activation region presents indicia representing the predetermined touchscreen function, wherein said functional activation region receives the indicia from the functional region of the touchscreen via said functional sense region.

20. The apparatus of claim 19, wherein said functional sense region senses the indicia presented by the functional region of the touchscreen.

21-42. (canceled)
